(19) United States
(12) Patent Application Publication
(10) Pub. No.: US 2005/0252741 A1
(43) Pub. Date: Nov. 17, 2005

(54) Manual brake application assembly

(76) Inventor: Royston Leonard Morris, Rogerstone (GB)

Correspondence Address: CARLSON, GASKEY & OLDS, P.C., 400 WEST MAPLE ROAD, SUITE 350, BIRMINGHAM, MI, 48009, US

(21) Appl. No.: 11/127,763

(22) Filed: May 12, 2005

(30) Foreign Application Priority Data
May 14, 2004 (GB) 0410844.5

(51) Int. Cl. F16D 55/08

(52) U.S. Cl. 188/355; 188/72.7; 188/72.9

(57) ABSTRACT

A manual brake application assembly for air actuated brakes, includes a frame including a threaded support, a complementary threaded rod for fitment within the threaded support; and a releasable securing arrangement to releasably secure the frame relative to a brake. The threaded rod is positioned relative to a component in an actuation transmission path of the brake, and the screwing in of the threaded rod actuates and applies the brake.

### REFERENCE TO RELATED APPLICATIONS

This application claims priority to United Kingdom Patent Application 0410844.5 filed on May 14, 2004.

### BACKGROUND OF THE INVENTION

The present invention relates generally to a manual brake application assembly. More particularly, the present application relates to a manual brake application assembly for air actuated brakes that may be used when there is a malfunction in the air actuation system or no air actuator is present.

Air actuated disc brakes are typically used in heavy vehicle applications, such as for braking trucks or buses. Such brakes typically operate as follow. Pressurized air is introduced behind a diaphragm of an air chamber, which generates a load in a push rod. The push rod in turn applies a force to a pivotably mounted operating shaft, causing it to rotate. By means of an eccentric action, an amplified force is applied to one or more tappet assemblies that advance a brake pad towards a brake rotor, causing a clamping effect on the brake rotor. This retards rotation of the brake rotor due to friction generated between the brake pad in contact with the tappet assembly and a further brake pad mounted on an opposite face of the brake rotor.

To comply with safety legislation, when a vehicle fitted with air actuated brakes is parked, the brakes must be applied mechanically without reliance on the pressurized air to overcome the risk of the brake force being removed due to the leakage of the air, with obvious consequences.

Conventionally, in air actuated brakes of the type described above, this parking brake function is achieved by the addition of a large spring to the rear chamber that generates a load on the push rod when no pressurized air is present.

In a co-pending patent application that claims priority to UK application GB 0410841.1, the Applicant has proposed using a mechanical latch which engages a surface on the operating shaft when in an actuated position as an alternative to the use of a conventional spring-type parking brake. To minimize the power requirement for the operation of the latch type parking brake, the service brake is applied before the latch can be brought into and out of contact with the operating-shaft to apply and release the parking brake.

In normal circumstances, a brake control system ensures that the service brake is applied as needed for the operation of the parking brake. However, if there is insufficient pressure for the service brake to be applied due to a malfunction, for example, this would not be possible. Similarly, during assembly or maintenance of the brake, it may have no air chamber fitted with which to apply the required force for operation of the service brake.

### SUMMARY OF THE INVENTION

The present invention provides an assembly that enables a service brake to be manually applied without the requirement for pressurized air.

Accordingly, a first aspect of the present invention provides a manual brake application assembly for air actuated brakes. The assembly includes a frame including a threaded support, a complementary threaded rod for fitment within the threaded support and a releasable securing arrangement to releasably secure the frame relative to a brake. The threaded rod is positioned relative to a component in an actuation transmission path of the brake. The screwing in of the threaded rod actuates and applies the brake.

A second aspect of the present invention provides a method of operating a manual brake application assembly for air actuated brakes. The assembly includes a frame including a threaded support, a complementary threaded rod for fitment within the threaded support and a releasable securing arrangement to releasably secure the frame relative to a brake. The threaded rod is positioned relative to a component in an actuation transmission path of the brake. The screwing in of the threaded rod actuates and applies the brake. The method includes the steps of securing the assembly to an air-actuated brake using the releasable securing arrangement and screwing the threaded rod into the threaded support until the brake is applied.

A third aspect of the invention provides a manual brake application assembly for air actuated brakes. The assembly includes a threaded support secured relative to a brake and a complementary threaded rod for adjustable positioning relative to a component in an actuation transmission path of the brake. The screwing in of the threaded rod actuates and applies the brake. The threaded support is provided on an air chamber of the brake, and the threaded support normally functions as an air inlet/outlet port or a diagnostic port.

### BRIEF DESCRIPTION OF THE DRAWINGS

Embodiments of the present invention will now be described, by way of example only, with reference to the accompanying drawings, in which:

FIG. 1 is a vertical cross-section through a disc brake adapted for use with an assembly according to one embodiment of the present invention;

FIG. 2 illustrates a latch parking brake in more detail;

FIG. 3 is a partial cut away view of an air chamber incorporating an assembly according to one embodiment of the present invention;

FIG. 4 is a partial cut away view of an air chamber incorporating an assembly according to one embodiment of the present invention; and

FIG. 5 illustrates an assembly according to a second embodiment of the present invention.

### DETAILED DESCRIPTION OF THE PREFFERED EMBODIMENT

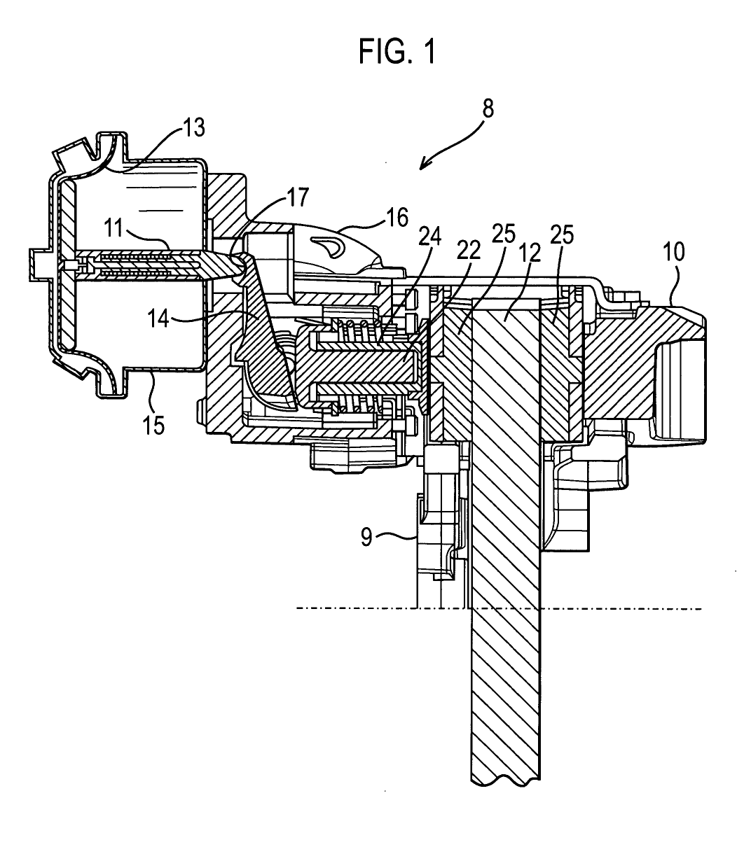

Referring to FIG. 1, a brake 8 includes a carrier 9 that is non-rotatably secured to a vehicle axle or a suspension which has a caliper 10 sidably mounted thereon. The caliper 10 straddles a disc or rotor 12 that is mounted for rotation together with a vehicle wheel to be braked (not shown). The brake 8 is actuated by the introduction of pressurized air behind a diaphragm 13 connected to a push rod 11. The push rod 11 co-operates with a socket 17 in the radially outer end of an operating shaft or “op-shaft” 14 of the brake 8. An inner end of the op-shaft 14 has at its opposite ends arcuate bearing surfaces 42 seated in bearing seats 43 arranged at a lower end of an inner housing part 16 of the caliper 10 to permit the op-shaft 14 to rotate about an axis that extends into the paper in FIG. 1. The inner end of the op-shaft 14 is provided with pockets positioned eccentric to the op-shaft axis of rotation which, upon rotation, causes a force to be transmitted to rollers 20. The rollers 20 in turn transmit an applied load to a pair of inner tappet members 22. The inner tappet members 22 are screwed into engagement with associated outer tappet members 24 which apply the load from the actuator to the rear of an inner brake pad 25, thus pressing the friction material of the inner brake pad 25 into friction engagement with the rotor 12.

A reaction force is generated through the frictional engagement between the rotor and the inner brake pad 25 that is fed back through the tappet members 22 and 24, the rollers 20 and the op-shaft 14 that is supported by the inner housing part 16. Since the caliper 10 is slidably mounted relative to the rotor 12 and straddles the rotor 12, the applied force generated by movement of the op-shaft 14 is ultimately transmitted by reaction to an outer brake pad 25A mounted on an opposite side of the rotor 12, which is also pressed into frictional engagement with the rotor 12. Therefore, the rotor 12, upon movement of the op-shaft 14, is clamped between the inner and outer brake pads 25 and 25A to generate a braking force for braking the vehicle under control of the applied input movement from the diaphragm 13 and the push rod 11. The diaphragm 13, the push rod 11, the op-shaft 14, the rollers 20, the inner tappet members 22 and the outer tappet members 24 constitute an actuation transmission path of the brake 8.

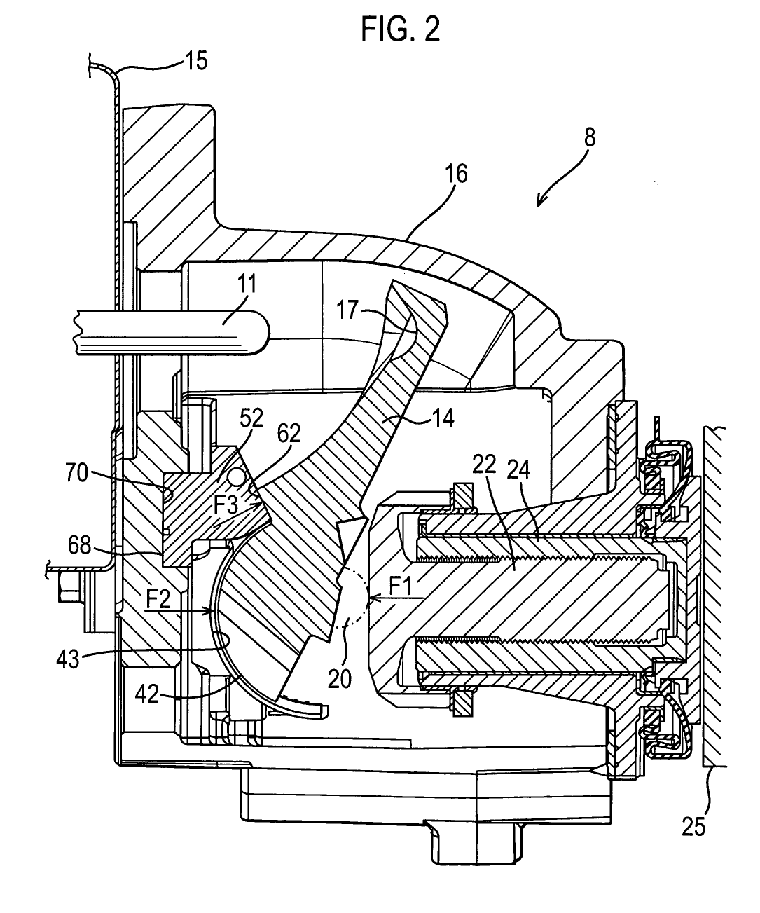

FIG. 2 illustrates a latch 52 in contact with a helical surface on the rear of the op-shaft 14 to provide a parking brake function of the brake 8. The latch 52 is drivable into and out of the paper of FIG. 2 by an electric motor (not shown) to engage and disengage the parking brake. To minimize cost and space requirements, the power output of the motor is relatively low. This means that the parking brake may only be applied and removed when the service brake is applied via the push rod 11 so that the motor does not have to overcome a high degree of friction between the latch 52 and an abutment surface 62.

This in turn means that if there were a failure in the service brake while the parking brake is applied, the vehicle to which the brake is fitted is effectively immobilized and cannot be towed away, for example. Similarly, if the parking brake is applied when a vehicle is being serviced when the air chamber 15 is removed, the service personnel have no means of releasing the parking brake in order to, for example, change the brake rotor.

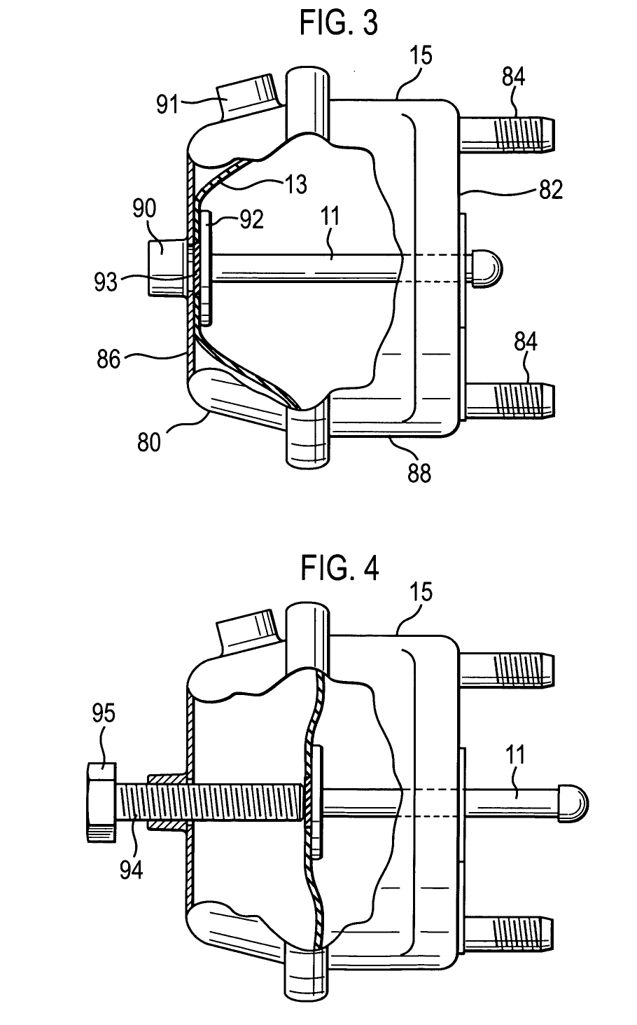

Referring now to FIGS. 3 and 4, the air chamber 15 incorporating an assembly according to one embodiment of the present invention is shown in more detail. The chamber includes a housing 80 having a front wall 82 arranged to be brought into face-to-face contact with an inboard rear face of the caliper 10 and to be attached thereto by bolts 84. The front wall 82 is provided with a hole (not visible) to enable the push rod 11 to protrude therethrough and move between the positions shown in FIGS. 3 and 4.

The air chamber 15 further includes a rear wall 86 that is spaced from the front wall 82 by a generally cylindrical side wall 88. The rear wall 86 includes an internally threaded port 90 axially in alignment with the push rod 11, which in normal circumstances may be connected to an air supply line from a vehicle air compressor and a valve arrangement that supplies the pressurized air to a region behind the diaphragm 13 to actuate the push rod 11 and apply the brake 8 and permit release of the air. Alternatively, the port 90 may be used as a pressure test port for diagnostics and the like. The side wall 88 includes a further port 91 that may also act either as an air inlet/outlet port or a diagnostic port.

In the interior of the air chamber 15, the push rod 11 terminates at its end nearest the rear wall 86 in a circular pressure plate 92 that functions to minimize the stresses applied to the diaphragm 13 when the pressurized air is introduced. A toughened diaphragm insert 93 is provided on the pressure plate 92 and axially in line with the push rod 11 and the inlet port 90. The insert 93 inhibits damage being caused to the diaphragm 13 due to the introduction of the threaded rod 94 shown in FIG. 4 and discussed below and may be made from any suitable material having sufficient bearing strength to withstand the load caused by the introduction of the push rod 11 to apply the brake 8. Examples of suitable material include plastics or ceramics. The insert 93 is molded integrally with the diaphragm 13 to form an airtight seal. In other embodiments, the insert 93 could be integral with the pressure plate 92 and provide a groove into which the diaphragm 13 locates to give an air tight seal. In a further variant, the insert 93 may be attached separately to the pressure plate 92, trapping the diaphragm 13 therebetween to form an air tight seal.

FIG. 4 shows a threaded rod 94 that has been introduced through the port 90 and screwed into contact with the insert 93 of the pressure plate 92. The threaded rod 94 preferably includes a hexagonal or other shaped head portion 95 to enable a standard spanner or wrench to be attached thereto so that a torque can be applied to rotate the threaded rod 94 and thereby apply the brake 8. In other embodiments, the head portion 95 may be replaced by an integral arm arranged transverse to the longitudinal axis of the threaded rod 94 so that no additional tools are required. A suitable torque limiting device may also be provided in the head portion 95 to prevent damage to the brake 8 due to excessive loads being applied via the threaded rod 94.

In certain embodiments, a tip of the threaded rod 94 in contact with the insert 93 may be provided with a low friction coating and/or a softer material than the remainder of the threaded rod 94 to further reduce the risk of damage being caused to the insert 93 and/or the pressure plate 92 or to provide a replacement for the insert 93.

When not required, the threaded rod 94 may be stored in association with the air chamber 15 so that it is readily available should the need arise. In certain embodiments, if the port 90 is not used as an air feed port, the threaded rod 94 may be permanently screwed into the port 90 in a retracted position so that it is almost immediately available for use. To protect it from damage due to corrosion or the like, a removable cap may be placed over the threaded rod 94 until it needs to be used.

Operation of the assembly is as follows. If not already fitted to the port 90, the threaded rod 94 is screwed into the port 90 and turned until the push rod 11 actuates the op-shaft 14. The threaded rod 94 is turned to apply the brake 8 to a sufficient extent such that the frictional resistance that prevents the disengagement of the parking brake latch 52 has reduced. The motor is then back-driven to release the parking brake latch 52. If re-application of the parking brake is required, the assembly is re-used to apply the service brake, the motor is driven to re-apply the parking brake latch 52, and the threaded rod 94 then is retracted.

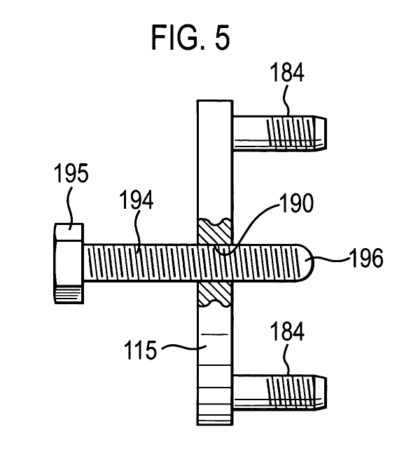

Turning to FIG. 5, an alternative embodiment of the present invention is illustrated. This embodiment provides a tool for the application of the service brake when the air chamber 15 is detached from the caliper 10. Such a tool may be required during the assembly or servicing of the brake 8 when no air chamber 15 is readily to hand. The assembly includes a cross member 115 with a pair of threaded bolts 184 mounted thereto with a mutual spacing configured to match threaded bores on the rear face of the caliper 10 that are usually used to mount the air chamber 15. In a preferred embodiment, the bolts 184 may be mounted to enable the spacing to be adjusted, for example, by providing the bolts 184 in slotted apertures on the cross member 115. This enables the assembly to fit a variety of different caliper models. Additionally, the cross member 115 may be configured to enable a variety of bolts 184 having differing diameters and thread types to be attached thereto and to enable the assembly to be used with a even wider variety of calipers.

The cross member 115 includes a threaded bore 190 at an appropriate location intermediate the bolts 184 to enable a threaded rod 194 to be fitted therethrough. As in the previous embodiment, the threaded rod 194 includes a head 195 so that spanners and wrenches may be fitted thereto. In other embodiments, a permanent handle may be secured in the same location instead. The threaded rod 194 may be fitted with a torque limiting device. An opposite end 96 of the threaded rod 194 is shaped to complement the socket 17 at the radially outermost end of the op-shaft 14, in much the same way as the push rod 11 that it replaces would do. In this embodiment, the opposite end 196 is rounded to fit into the socket 17. In other embodiments, the threaded bore 190 is able to pivot to a limited degree (e.g., by being provided in a non-rotatable ball joint on the cross member 115) to permit the opposite end 196 of the threaded rod 194 to follow the arc described by the op-shaft socket 17 as it moves to apply the brake 8.

To use the assembly, the bolts 184 are first screwed into the corresponding holes on the rear face of the caliper 10 after any required alignment adjustments are made. A suitable spanner or wrench is then fitted to the head 195 of the threaded rod 194, and this is turned until the op-shaft 14 has been actuated to a sufficient extent that the parking brake latch 52 may be released or applied. The threaded rod 194 is then retracted, and the bolts 184 are unscrewed to remove the assembly.

Terms such as “inner”, “outer”, “upper” and “lower” are used herein for ease of reference and should not be regarded as limiting. In the context of this application, the term “manual” should be understood to mean an assembly that is that does not form part of the normal means provided in the brake for service or parking braking, but rather an assembly only used in during brake assembly, maintenance or emergency situations. Although the term “manual” has been used, this does not preclude an assembly that is attachable to a power tool or is provided with its own power source falling within the scope of the present invention.

It will be appreciated that a variety of changes may be made within the scope of the present invention. For example, suitable assemblies may be used on air chambers mounted at 90° to the position illustrated in FIG. 1, for example above or at the side of the caliper 10. If the air chamber 15 has no suitably located inlet port, a threaded bore may be provided solely for the purpose of use with the threaded rod 94. The bore may be provided with a cap to close it off when not in use. The present invention may also be used on other types of air-actuated disc brakes, such as fixed-caliper brakes, for example.

The foregoing description is only exemplary of the principles of the invention. Many modifications and variations are possible in light of the above teachings. It is, therefore, to be understood that within the scope of the appended claims, the invention may be practiced otherwise than using the example embodiments which have been specifically described. For that reason the following claims should be studied to determine the true scope and content of this invention.

1. A manual brake application assembly for an air actuated brake comprising:
a frame including a threaded support;
a complementary threaded rod for fitment within the threaded support, wherein the complementary threaded rod is positioned relative to a component in an actuation transmission path of the air actuated brake; and
a releasable securing arrangement to releasably secure the frame relative to the air actuated brake, wherein threading the complementary threaded rod actuates and applies the air actuated brake.

2. The manual brake application assembly according to claim 1 wherein the frame is releasably securable to an air chamber mount on the air actuated brake.

3. The manual brake application assembly according to claim 2 wherein the releasable securing arrangement includes at least two bolts configured to thread into the air chamber mount.

4. The manual brake application assembly according to claim 3 wherein the frame includes a cross-member extending between the at least two bolts and provided with the threaded support.

5. The manual brake application assembly according to claim 1 wherein the actuation transmission path includes an op-shaft having a push rod socket, and the complementary threaded rod engages the push rod socket of the op-shaft when the complementary threaded rod is received in the threaded support.

6. The manual brake application assembly according to claim 1 wherein the complementary threaded rod includes a first end shaped to complement a point of contact with the component in the actuation transmission path.

7. The manual brake application assembly according to claim 6 wherein the complementary threaded rod includes a second end having a formation, and a tool can attach to the second end of the complementary threaded rod.

8. The manual brake application assembly according to claim 1 further including a brake transmission path component having a strengthening insert contactable with the complementary threaded rod.

9. A method of operating a manual brake application assembly comprising the steps of:
securing the manual brake application assembly to an air actuated brake with a releasable securing arrangement; and
threading a complementary threaded rod into a threaded support of a frame until the air actuated brake is applied, wherein the complementary threaded rod is positioned relative to a component in an actuation transmission path of the air actuated brake.

10. A manual brake application assembly for an air actuated brake comprising
a threaded support secured relative to the air actuated brake; and
a complementary threaded rod for adjustable positioning relative to a component in an actuation transmission path of the air actuated brake, wherein threading of the complementary threaded rod actuates and applies the air actuated brake, the threaded support is provided on an air chamber of the air actuated brake, and the threaded support functions as one of an air inlet/outlet port and a diagnostic port.

11. The manual brake application assembly according to claim 10 wherein the air chamber includes a rear face, and the threaded support is provided on the rear face of the air chamber.

12. The manual brake application assembly according to claim 10 wherein the actuation transmission path includes a push rod and the complementary threaded rod is substantially axially aligned with the push rod when the complementary threaded rod is received in the threaded support.

13. The manual brake application assembly according to claim 10 wherein the complementary threaded rod includes a first end shaped to complement a point of contact with the component in the actuation transmission path.

14. The manual brake application assembly according to claim 13 wherein the complementary threaded rod includes a second end having a formation, and tool can attach to the second end of the complementary threaded rod.

15-16. (canceled)
